(19) United States
(12) Patent Application Publication
(10) Pub. No.: US 2025/0118824 A1
(43) Pub. Date: Apr. 10, 2025

(54) BATTERY PACK

(71) Applicant: SAMSUNG SDI CO., LTD., Yongin-si (KR)

(72) Inventors: Nohyun KWAG, Yongin-si (KR); Daeyeop PARK, Yongin-si (KR); Kumyul HWANG, Yongin-si (KR); Jaeseung KIM, Yongin-si (KR)

(21) Appl. No.: 18/905,274

(22) Filed: Oct. 3, 2024

(30) Foreign Application Priority Data
Oct. 4, 2023 (KR) 10-2023-0131908

(51) Int. Cl. H01M 10/6554; H01M 10/653; H01M 50/204; H01M 50/271; H01M 50/367; H01M 50/507

(52) U.S. Cl. CPC H01M 10/6554; H01M 10/653; H01M 50/271; H01M 50/367; H01M 50/507; H01M 50/204

(57) ABSTRACT

A battery pack includes plurality of battery cells, with each of the battery cells including a vent. A housing accommodates the battery cells and a cover covers an upper surface of the housing. A bus bar connects the plurality of battery cells to each other. A heat sink is positioned on the cover. A heat transfer material is applied to the bus bar and covers at least a part of the heat sink. The heat sink includes a body including a plurality of windows that are positioned to correspond to the vents of the battery cells, and a leg extending from the body toward the bus bar.

### CROSS-REFERENCE TO RELATED APPLICATION

The present application claims priority and the benefit of Korean Patent Application No. 10-2023-0131908, filed on Oct. 4, 2023, in the Korean Intellectual Property Office, the entire disclosure of which is incorporated herein by reference.

### BACKGROUND

### 1. Field

One or more embodiments relate to a battery pack.

### 2. Description of the Related Art

A secondary battery refers to a chargeable and dischargeable battery, unlike a primary battery that is not chargeable. Secondary batteries are used as energy sources for mobile devices, electric vehicles, hybrid vehicles, electric bicycles, uninterruptible power supplies, etc. According to the type of external device they are applied to, secondary batteries are used in the form of a single battery or in the form of a pack in which a plurality of battery cells are connected and grouped into one unit.

Recently, as the capacity of battery cells has increased, and the number of battery cells included in battery packs has increased, excessive heat is generated in bus bars, which can cause damage to the bus bars and the battery cells. Therefore, it is necessary to improve the heat dissipation structure of bus bars.

The background art described herein is technical information possessed by the inventor for deriving the present disclosure or acquired in the process of deriving the present disclosure, and is not necessarily a known technology disclosed to the general public before the filing of the present disclosure.

### SUMMARY

One or more embodiments include a battery pack that may efficiently discharge heat generated from a bus bar during use of the battery pack through an improved heat dissipation structure.

However, the problems to be solved by the present disclosure the disclosure are not limited.

Additional aspects will be set forth in part in the description which follows and will be apparent from the description, or may be learned by practice of the presented embodiments of the present disclosure.

According to one or more embodiments, a battery pack includes a plurality of battery cells, each of the battery cells including a vent, a housing accommodating the battery cells, a cover covering an upper surface of the housing, a bus bar connecting the battery cells to each other, a heat sink is positioned on the cover, and a heat transfer material applied to the bus bar and covering at least a part of the heat sink, wherein the heat sink includes a body including a plurality of windows that are positioned to correspond to vents of the plurality of battery cells, and a leg extending from the body toward the bus bar.

The legs may be spaced apart from the bus bar in a height direction.

The leg may include a connection portion extending downward from the body, and an extension portion extending from the connection portion in a longitudinal direction of the battery pack and at least partially surrounded by the heat transfer material.

An upper surface of the heat transfer material may be positioned above an upper surface of the extension portion.

The heat transfer material may be applied to one or more protrusion portions and one or more recesses formed in the bus bar.

The housing may include a detachable upper case, the upper case may include a rib extending in a longitudinal direction of the battery pack, and the heat transfer material may be accommodated between the bus bar and the rib.

The rib may include a plurality of ribs arranged side by side in the longitudinal direction of the battery pack, and the plurality of ribs partitions a region in which the battery cells are accommodated in the housing.

An upper end of the rib may be positioned above an upper surface of the bus bar.

The bus bar may include a first bus bar, a second bus bar, and a third bus bar that connect the plurality of battery cells to each other, and the heat transfer material may be applied to each of the first bus bar, the second bus bar, and the third bus bar.

The first bus bar may be positioned at a center in the longitudinal direction of the battery pack, and include a first protrusion portion and a first concave portion adjacent to the first protrusion portion, the heat sink may comprise two heat sinks that face each other, and the heat transfer material may be accommodated on the first protrusion portion and the first concave portion and is between the two heat sinks.

At least a part of the leg may be above the first concave portion.

The battery pack may further include a wall portion extending upward from the first protrusion portion and dividing the heat transfer material applied to the first bus bar into two parts.

The second bus bar may include a plurality of second bus bars positioned on both sides of the battery back in the longitudinal direction, each of the second bus bars may include a second protrusion portion and a second concave portion adjacent to the second protrusion portion, and the heat transfer material may be accommodated on the second protrusion portion and in the second concave portion.

The second protrusion portion may have a T-shape, the second concave portion may include two second concave portions facing each other with a part extending from the second protrusion portion disposed between the two concave portions, and the two second concave portions may correspond to different battery cells.

The heat transfer material applied to the second bus bar may cover at least a part of the leg of the heat sink in the longitudinal direction of the battery pack.

At least a part of a leg of the heat sink may be positioned above the second concave portion.

The third bus bar may be positioned on one side of the battery pack in the longitudinal direction, and the third bus bar may include a third protrusion portion and a third concave portion adjacent to the third protrusion portion, and the heat transfer material may be accommodated on the third protrusion portion and the third concave portion.

The third bus bar may include a connection portion adjacent to the third concave portion, and the heat transfer material may be applied to the connection portion and covers at least a part of the leg the heat sink in the longitudinal direction of the battery pack.

At least a part of a leg of the heat sink may be positioned above the third concave portion.

According to one or more embodiments, a battery pack includes a plurality of battery cells, each of the battery cells including a vent, a housing accommodating the battery cells and including an upper case that includes the rib, a cover covering an upper surface of the housing, a bus bar connecting the plurality of battery cells to each other and including at least one protrusion portion and at least one concave portion, a heat sink positioned on the cover, the heat sink including a body including a plurality of windows that are positioned to correspond to the vents of the plurality of battery cells, and a leg extending from the body toward the bus bar and positioned above the upper surface of the bus bar, and a heat transfer material accommodated on the at least one protrusion portion, in the at least one concave portion, on the rib, and covering at least a part of the heat sink.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 shows a battery pack;

FIG. 2 shows an exploded perspective view of the battery pack of FIG. 1;

FIG. 3 shows a part of a housing, a bus bar, and a heat sink;

FIG. 4 shows a part of a housing and a bus bar;

FIG. 5 is an enlarged view of a bus bar and a heat sink, mounted on a housing;

FIG. 6 shows a first bus bar;

FIG. 7 shows a second bus bar;

FIG. 8 shows a third bus bar;

FIG. 9 shows a cover on which a heat sink is mounted;

FIG. 10 shows a heat sink;

FIG. 11 is a cross-sectional view taken along line A-A′ of FIG. 3;

FIG. 12 is a cross-sectional view taken along line B-B′ of FIG. 3;

FIG. 13 is a cross-sectional view taken along line C-C′ of FIG. 3; and

FIG. 14 is a cross-sectional view taken along line A-A′ of FIG. 3 according to embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are described below, by referring to the figures, to explain aspects of the present description. As used herein, the term “and/or” includes any and all combinations of one or more of the associated listed items. Expressions such as “at least one of,” if preceding a list of elements, modify the entire list of elements and do not modify the individual elements of the list.

Aspects of some embodiments of the present disclosure and methods of accomplishing the same may be understood more readily by reference to the detailed description of embodiments and the accompanying drawings. Hereinafter, embodiments will be described in more detail with reference to the accompanying drawings. The described embodiments, however, may have various modifications and may be embodied in different forms, and should not be construed as being limited to only the illustrated embodiments herein. Further, each of the features of the various embodiments of the present disclosure may be combined or combined with each other, in part or in whole, and technically various interlocking and driving are possible. Each embodiment may be implemented independently of each other or may be implemented together in an association. The described embodiments are provided as examples so that this disclosure will be thorough and complete, and will fully convey the aspects of the present disclosure to those skilled in the art. It should be understood that the present disclosure covers all the modifications, equivalents, and replacements within the idea and technical scope of the present disclosure. Accordingly, processes, elements, and techniques that are not necessary to those having ordinary skill in the art for a complete understanding of the aspects of the present disclosure may not be described.

Unless otherwise noted, like reference numerals, characters, or combinations thereof denote like elements throughout the attached drawings and the written description, and thus, descriptions thereof will not be repeated. Further, parts that are not related to, or that are irrelevant to, the description of the embodiments might not be shown to make the description clear.

In the drawings, the relative sizes of elements, layers, and regions may be exaggerated for clarity. Additionally, the use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified.

Various embodiments are described herein with reference to sectional illustrations that are schematic illustrations of embodiments and/or intermediate structures. As such, variations from the shapes of the illustrations as a result, for example, of manufacturing techniques and/or tolerances, are to be expected. Further, specific structural or functional descriptions disclosed herein are merely illustrative for the purpose of describing embodiments according to the concept of the present disclosure. Thus, embodiments disclosed herein should not be construed as limited to the illustrated shapes of regions, but are to include deviations in shapes that result from, for instance, manufacturing.

For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place.

Thus, the regions illustrated in the drawings are schematic in nature and their shapes are not intended to illustrate the actual shape of a region of a device and are not intended to be limiting. Additionally, as those skilled in the art would realize, the described embodiments may be modified in various ways, all without departing from the spirit or scope of the present disclosure.

In the detailed description, for the purposes of explanation, numerous specific details are set forth to provide a thorough understanding of various embodiments. It is apparent, however, that various embodiments may be practiced without these specific details or with one or more equivalent arrangements. In other instances, well-known structures and devices are shown in block diagram form to avoid unnecessarily obscuring various embodiments.

Spatially relative terms, such as “beneath,” “below,” “lower,” “lower side,” “under,” “above,” “upper,” “upper side,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” may encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

Further, the phrase “in a plan view” means when an object portion is viewed from above, and the phrase “in a schematic cross-sectional view” means when a schematic cross-section taken by vertically cutting an object portion is viewed from the side. The terms “overlap” or “overlapped” mean that a first object may be above or below or to a side of a second object, and vice versa. Additionally, the term “overlap” may include layer, stack, face or facing, extending over, covering, or partly covering or any other suitable term as would be appreciated and understood by those of ordinary skill in the art. The expression “not overlap” may include meaning, such as “apart from” or “set aside from” or “offset from” and any other suitable equivalents as would be appreciated and understood by those of ordinary skill in the art. The terms “face” and “facing” may mean that a first object may directly or indirectly oppose a second object. In a case in which a third object intervenes between a first and second object, the first and second objects may be understood as being indirectly opposed to one another, although still facing each other.

It will be understood that when an element, layer, region, or component is referred to as being “formed on,” “on,” “connected to,” or “(operatively or communicatively) coupled to” another element, layer, region, or component, it may be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it may be directly electrically connected or coupled to the other layer, region, and/or component or intervening layers, regions, or components may be present. However, “directly connected/directly coupled,” or “directly on,” refers to one component directly connecting or coupling another component, or being on another component, without an intermediate component. In addition, in the present specification, when a portion of a layer, a film, a region, a plate, or the like is formed on another portion, a forming direction is not limited to an upper direction but includes forming the portion on a side surface or in a lower direction. On the contrary, when a portion of a layer, a film, a region, a plate, or the like is formed “under” another portion, this includes not only a case where the portion is “directly beneath” another portion but also a case where there is further another portion between the portion and another portion. Meanwhile, other expressions describing relationships between components such as “between,” “immediately between” or “adjacent to” and “directly adjacent to” may be construed similarly. In addition, it will also be understood that when an element or layer is referred to as being “between” two elements or layers, it may be the only element or layer between the two elements or layers, or one or more intervening elements or layers may also be present.

For the purposes of this disclosure, expressions such as “at least one of,” or “any one of,” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expression such as “at least one of A and B” and “at least one of A or B” may include A, B, or A and B. As used herein, “or” generally means “and/or,” and the term “and/or” includes any and all combinations of one or more of the associated listed items. For example, the expression such as “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

The terminology used herein is for the purpose of describing particular embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

When one or more embodiments may be implemented differently, a specific process order may be performed differently from the described order. For example, two consecutively described processes may be performed substantially at the same time or performed in an order opposite to the described order.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value. Further, the use of “may” when describing embodiments of the present disclosure refers to “one or more embodiments of the present disclosure.”

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

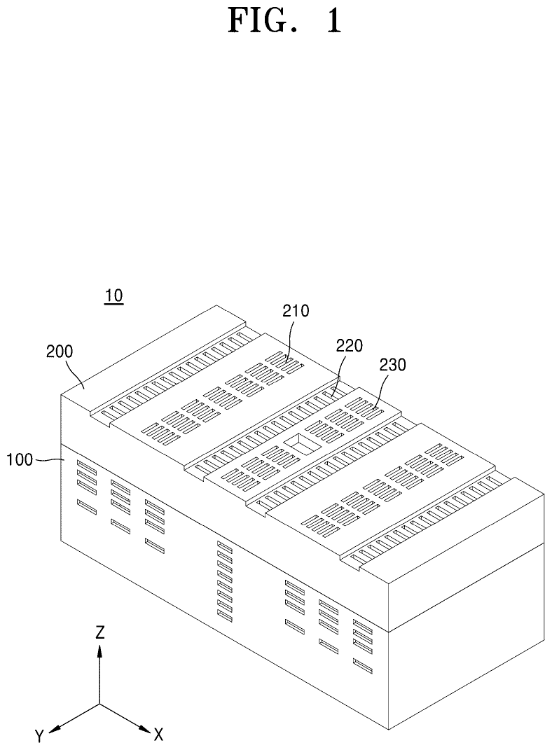

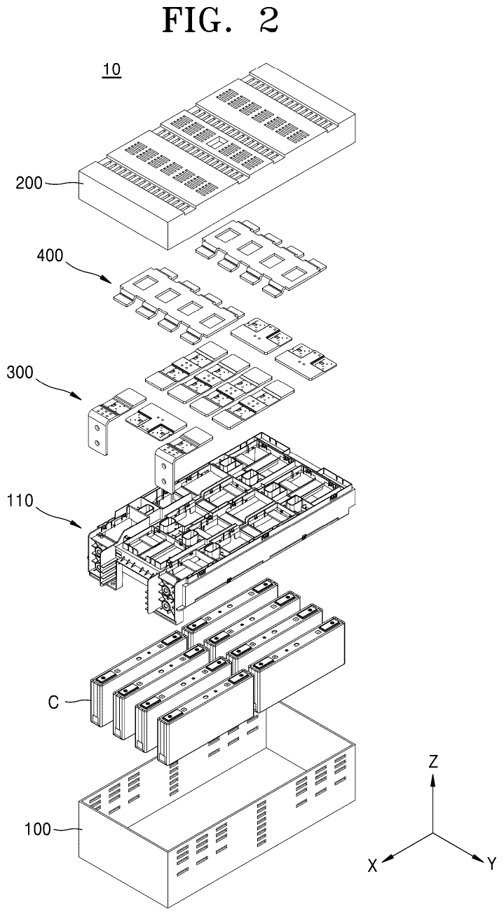

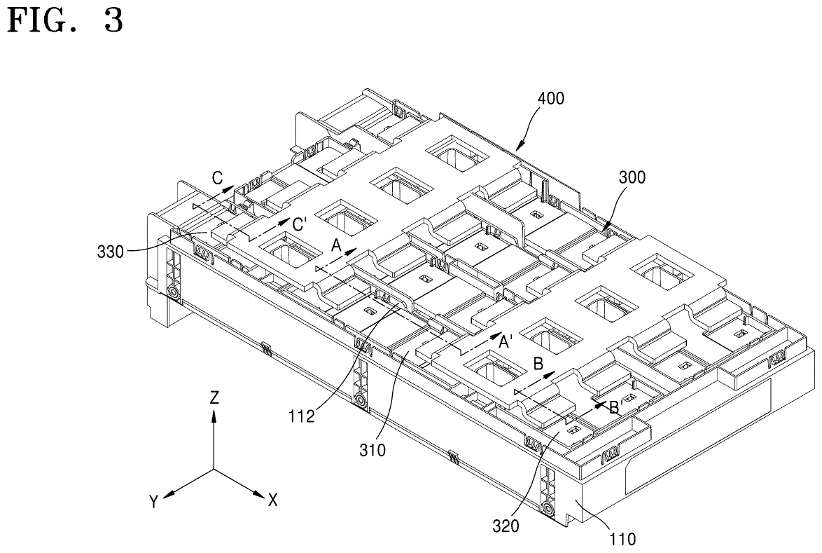

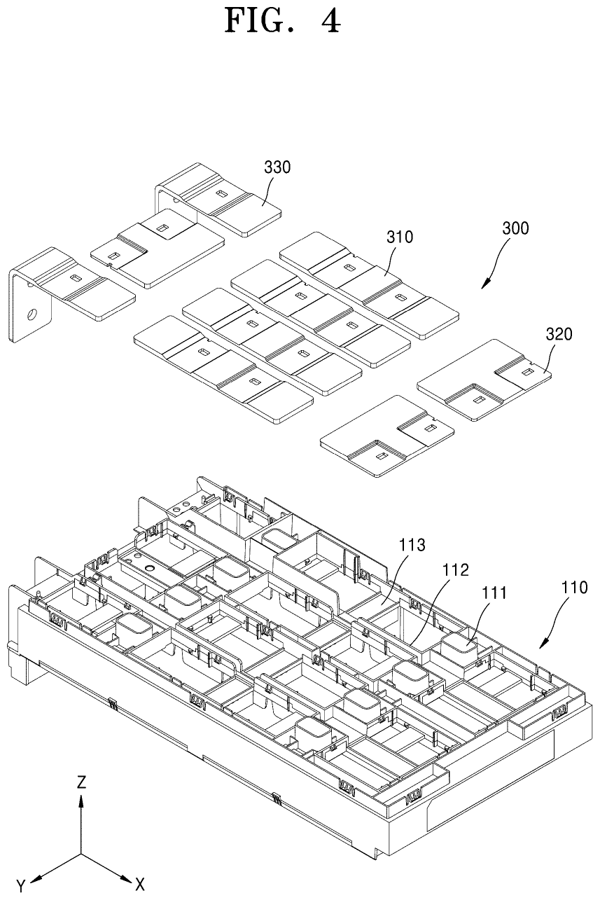

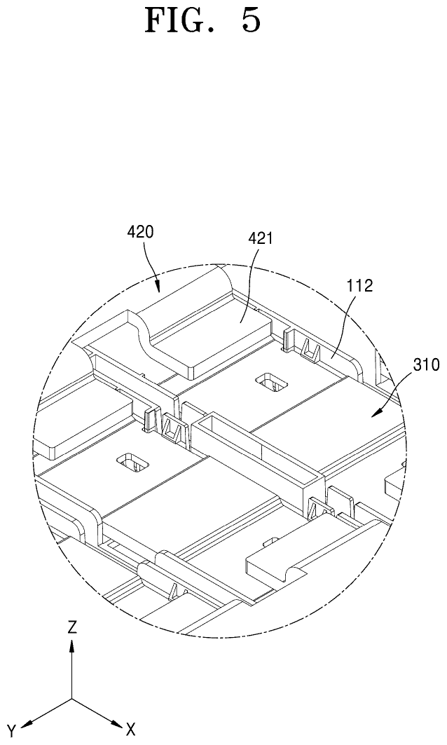

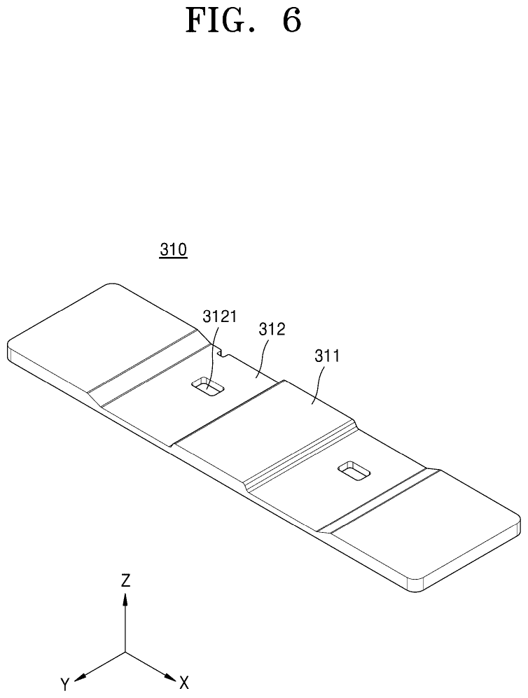

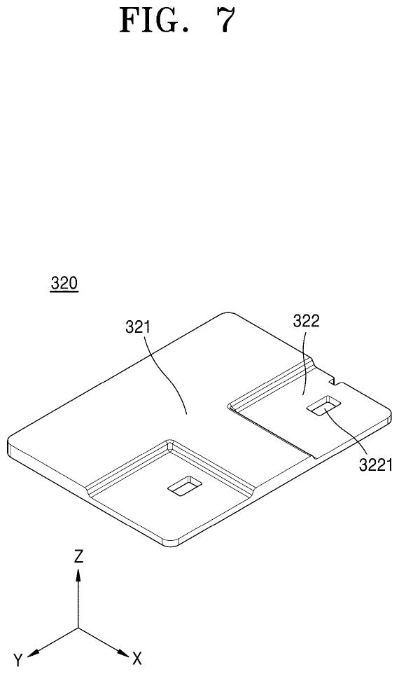

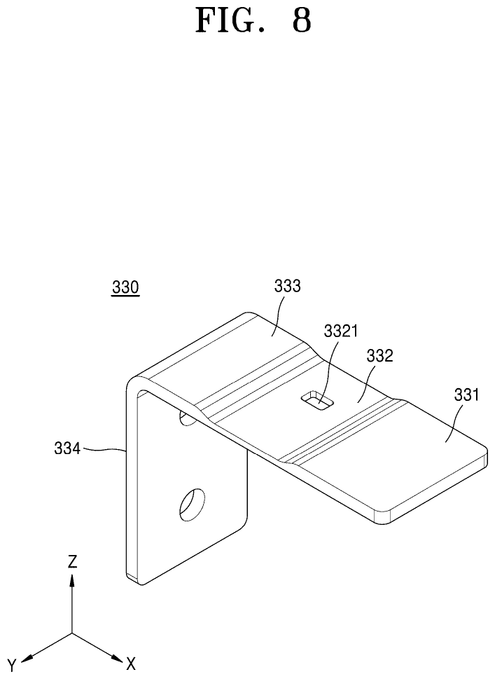

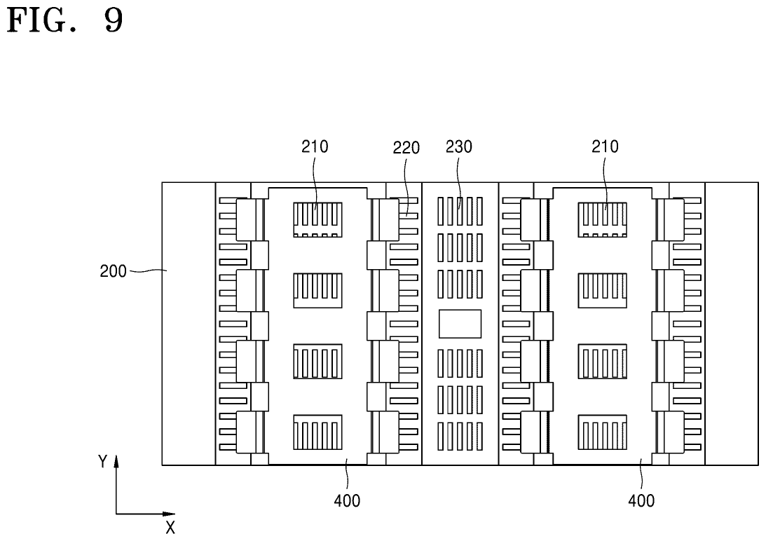

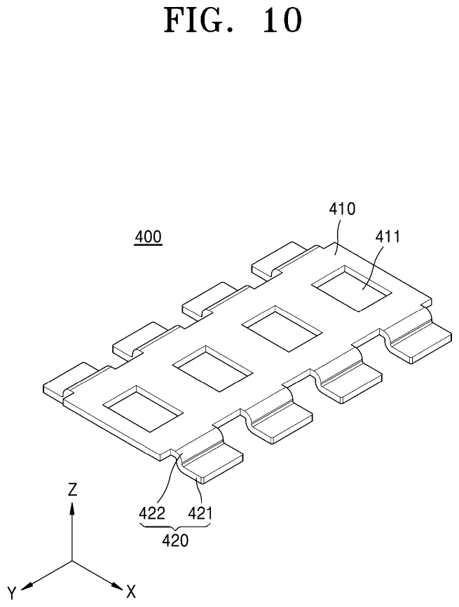

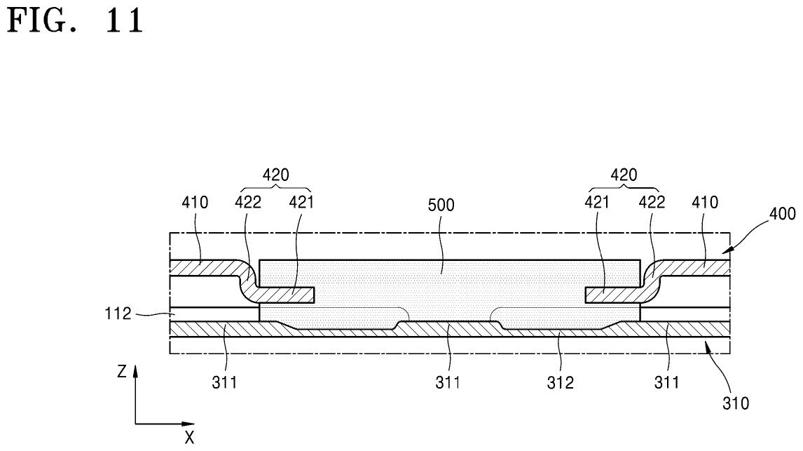

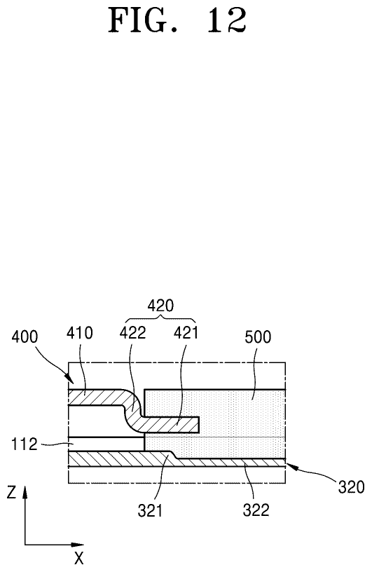

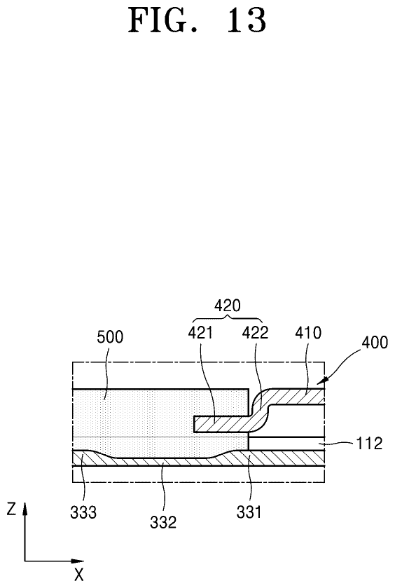

FIG. 1 shows a battery pack 10. FIG. 2 shows an exploded perspective view of the battery pack 10 of FIG. 1. FIG. 3 shows a part of the housing 100, a bus bar 300, and a heat sink 400. FIG. 4 shows a part of the housing and the bus bar 300. FIG. 5 is an enlarged view of the bus bar and a heat sink mounted on the housing. FIG. 6 shows a first bus bar 310. FIG. 7 shows a second bus bar 320. FIG. 8 shows a third bus bar 330. FIG. 9 shows a cover on which a heat sink 400 is mounted. FIG. 10 shows the heat sink 400. FIG. 11 is a cross-sectional view taken along line A-A′ of FIG. 3. FIG. 12 is a cross-sectional view taken along line B-B′ of FIG. 3. FIG. 13 is a cross-sectional view taken along line C-C′ of FIG. 3.

The battery pack 10, which includes a plurality of battery cells C, may be applied to a large application such as an energy storage system (ESS). For example, the battery pack 10 may be applied to power commercial applications, household applications, communication application, or uninterruptible power supplies (UPS). For example, the battery pack 10 may be applied to a vehicle battery or a small and medium-sized application such as a desktop, a tablet, a smartphone, or a laptop.

The battery pack 10 may include the housing 100 accommodating the plurality of battery cells C, the cover 200 covering an upper surface of the housing 100, the bus bar 300 connecting the plurality of battery cells C to each other, the heat sink 400 disposed in the cover 200, and a heat transfer material 500 applied to the bus bar 300 and covering at least a part of the heat sink 400. The heat sink 400 may include a body 410 including a plurality of windows 411 corresponding to vents of the plurality of battery cells C, and the heat sink 400 may include a leg 420 extending downward from the body 410 toward the bus bar 300.

The housing 100 may include an upper case 110 that accommodates the plurality of battery cells C and a rib 112 extending in one direction (e.g., a longitudinal direction of the battery pack 10 or an X-axis direction of FIG. 3). The cover 200 covers the upper surface of the housing 100. The bus bar 300 connects the plurality of battery cells C to each other and includes one or more protrusion portions and one or more concave portions at an upper surface. The heat sink 400 is disposed in the cover 200 and includes the body 410 that includes the plurality of windows 411 corresponding to the vents of the plurality of battery cells C and the leg 420 extending downward from the body 410 toward the bus bar 300 (but the leg 420 is spaced upward from the upper surface of the bus bar 300). The heat transfer material 500 is accommodated on the one or more protrusion portions, in the one or more concave portions, and on the rib 112 so as to cover at least a part of the heat sink 400.

The battery cells C included in the battery pack 10 may have a prismatic shape, a pouch shape, or a cylindrical shape. Hereinafter, for convenience of description, it is mainly described that the battery cells C have the prismatic shape. There may be the plurality of battery cells C. The number of battery cells C may be selected according to the specifications of the battery pack 10. For example, one battery pack 10 may include a total of eight battery cells C. As another example, one battery pack 10 may include eight or less or eight or more battery cells C. Hereinafter, for convenience of description, it is mainly described that a total of eight battery cells C are included in one battery pack 10.

The plurality of battery cells C may be connected in series and/or in parallel to each other. For example, the eight battery cells C may be connected in series of two such that four pairs of battery cells C connected in series are formed, and the four pairs of battery cells C may be connected in parallel to each other. Thus, the plurality of battery cells C may be connected to each other in different serial/parallel structures.

The battery pack 10 may include the housing 100, the cover 200, the bus bar 300, the heat sink 400, and the heat transfer material 500.

The housing 100 may accommodate the plurality of battery cells C. For example, the housing 100 may include an inner space and have a substantially rectangular parallelepiped shape. The housing 100 may include one or more heat dissipation slits in at least one surface. The housing 100 may include the inner space partitioned by a plurality of side surfaces and bottom surfaces, and the plurality of battery cells C may be accommodated in the inner space.

The housing 100 may include the upper case 110. The upper case 110 may be detachably coupled to the housing 100. When the upper case 110 is separated from the housing 100, the plurality of battery cells C may be accommodated in the housing 100, and the upper case 110 thereafter may be mounted on the housing 100. The upper case 110 may be mounted on an upper portion of the housing 100 and may include a vent hole 111, the rib 112, and a partition wall 113.

The vent hole 111 may include a plurality of vent holes 111 corresponding to vent holes of plurality of battery cells C. If an abnormality occurs in one or more of the battery cells C and gas is discharged from the vent hole(s) of the battery cell(s) C, the vent holes 111 may discharge the gas to outside of the battery pack 10 so that the gas does not remain in the battery pack 10. The vent hole 111 may correspond to the window 411 formed in the body 410 of the heat sink 400. The vent hole 111 may extend upward by a certain height so that an upper end thereof may face a first heat dissipation slit 210 formed in the cover 200. Therefore, the vent hole 111 may minimize the transfer of the gas discharged from the vent hole of the battery cell C to another portion of the battery pack 10.

The rib 112 may be included in the upper case 110 and may partition a region in which the plurality of battery cells C are accommodated. The rib 112 may include a plurality of ribs 112. The plurality of ribs 112 may be arranged in parallel in the longitudinal direction (e.g., the X-axis direction of FIG. 3) of the battery pack 10 inside the upper case 110. The rib 112 may protrude upward more than upper surfaces of the plurality of battery cells C in order to hold and support the heat transfer material 500 together with the bus bar 300 and the heat sink 400. Further, the ribs 112 may protrude further above the upper surface of the bus bar 300.

The plurality of ribs 112 may be spaced apart in a width direction (e.g., Y-axis direction) of the battery pack 10, and the plurality of battery cells C may be disposed between the ribs 112. Two battery cells C may be disposed in one direction (e.g., the X-axis direction) between the plurality of ribs 112, and may be connected in series to each other. The ribs 112 may be formed over the entire length of the upper case 110. The ribs 112 may be discontinuously formed in the longitudinal direction (e.g., the X-axis direction of FIG. 3) of the upper case 110.

The upper end of the ribs 112 may be above the bus bar 300 and below the heat sink 400. The upper end of the ribs 112 may be above the bus bar 300 and the heat sink 400.

The partition wall 113 may extend across the upper case 110. For example, the partition wall 113 may extend in the width direction (e.g., the Y-axis direction) of the battery pack 10, be disposed between the battery cells C adjacent in the longitudinal direction (e.g., the X-axis direction of FIG. 4) of the battery pack 10, and partition a region in which the battery cells C are mounted together with the rib 112. The rib 112 may partition a region in which the plurality of battery cells C are mounted in the width direction of the battery pack 10, and the partition wall 113 may partition a region in which the plurality of battery cells C are mounted in the longitudinal direction of the battery pack 10.

The upper end of the rib 112 may be above the upper end of the partition wall 113. The upper end of the rib 112 may be above the upper surface of the bus bar 300. Therefore, while the heat transfer material 500 is applied to the bus bar 300, the heat transfer material 500 may be stably held and supported by the rib 112.

The cover 200 may be detachably mounted on the upper surface of the housing 100 so as to cover the housing 100. As shown in FIGS. 1 and 2, the cover 200 may be disposed on the uppermost portion of the battery pack 10 and may prevent external foreign substances from being introduced into the battery pack 10. The cover 200 may be mounted on the upper case 110 to cover the upper case 110 of the housing 100. The cover 200 may have an inner space, and the heat sink 400 may be on an upper inner surface of the cover 200 while the heat sink 400 is accommodated in the inner space. The plurality of battery cells C may be accommodated in the housing 100 and the upper case 110 may be mounted on the housing 100, the bus bar 300 may electrically connect the plurality of battery cells C to each other, and then the cover 200 may be mounted on the upper case 110. The heat sink 400 may be mounted inside the cover 200.

The cover 200 may include the first heat dissipation slit 210, a second heat dissipation slit 220, and a third heat dissipation slit 230. A plurality of first heat dissipation slits 210, second heat dissipation slits 220, and third heat dissipation slits 230 may be formed through the cover 200 and may discharge heat generated by the battery pack 10 to outside of the battery pack 10. For example, if gas is generated due to an abnormal operation of the battery pack 10, gas may be discharged to outside of the battery pack through the slits 210, 220, and 230. As such, the first heat dissipation slits 210, second heat dissipation slits 220, and third heat dissipation slits 230 may be formed on the upper surface of the cover 200.

The cover 200 may include one or more protrusion portions and concave portions forming a step with each other on the upper surface. The first heat dissipation slits 210, the second heat dissipation slits 220, and the third heat dissipation slits 230 may be formed in the protrusion portions and the concave portions. For example, as shown in FIG. 1, the cover 200 may include a protrusion portion in a part corresponding to the vent holes of the plurality of battery cells C, and the plurality of first heat dissipation slits 210 may be formed in the corresponding protrusion portion. Concave portions may be formed on both sides of the protrusion portion in the longitudinal direction (e.g., the X-axis direction of FIG. 1) with respect to the battery pack 10, and the plurality of second heat dissipation slits 220 may be formed in the concave portions. A protrusion portion may be formed in the center in the longitudinal direction of the battery pack 10, and the plurality of third heat dissipation slits 230 may be formed in this protrusion portion. Therefore, as shown in FIG. 1, a plurality of heat dissipation slits may be formed over the entire upper surface of the battery pack 10, and, thus, heat and gas generated by the battery pack 10 may be smoothly discharged to outside of the battery pack 10.

The first heat dissipation slit 210, the second heat dissipation slit 220, and the third heat dissipation slit 230 may have different arrangements in the longitudinal direction of the battery pack 10. For example, as shown in FIG. 1, the plurality of second heat dissipation slits 220 may be formed in the outermost side in the longitudinal direction of the battery pack 10, and the plurality of second heat dissipation slits 220 may be arranged in parallel with the longitudinal direction of the battery pack 10. The first heat dissipation slits 210 may be arranged inside of the second heat dissipation slits 220 in the longitudinal direction of the battery pack 10 and differently from the second heat dissipation slits 220 (e.g., arranged in parallel with the width direction of the battery pack 10). Also, the third heat dissipation slits 230 may be arranged inside of the first heat dissipation slits 210 in the longitudinal direction of the battery pack 10 and in the same manner as the first heat dissipation slits 210 (e.g., arranged in parallel with the width direction of the battery pack 10). Therefore, heat and gas generated from the battery pack 10 may be smoothly discharged to outside of the battery pack 10.

FIG. 1 illustrates that the plurality of first heat dissipation slits 210, second heat dissipation slits 220, and third heat dissipation slits 230 are arranged side by side in the longitudinal direction (e.g., X-axis direction) and width direction (e.g., Y-axis direction) of the battery pack 10. But the plurality of first heat dissipation slits 210, second heat dissipation slits 220, and third heat dissipation slits 230 may be arranged in various directions and angles.

The bus bar 300 may electrically connect the plurality of battery cells C to each other. The bus bar 300 may be a conductor, for example, a metal such as aluminum or copper. The bus bar 300 may disposed on one side (e.g., an upper surface) of the plurality of battery cells C, and may connect the adjacent battery cells C in series/parallel. A plurality of bus bars 300 may each connect two battery cells C in series and connect the battery cells C in parallel to each other to form a 4 parallel (4P) 2 series (2S) connection structure. The bus bar 300 may be connected to a battery management system (BMS) outside the battery pack 10 to transfer information about voltage and charging states of the battery cell C.

The bus bar 300 may include a first bus bar 310, a second bus bar 320, and a third bus bar 330 connecting the plurality of battery cells C to each other. The heat transfer material 500 may be applied to each of the first bus bar 310, the second bus bar 320, and the third bus bar 330.

The first bus bar 310 may be at the center in the longitudinal direction of the battery pack 10 and connect the plurality of battery cells C to each other. The first bus bar 310 may have a flat bar shape and connect two battery cells C that are adjacent in the longitudinal direction of the battery pack 10 (e.g., the X-axis direction) in series. As shown in FIG. 4, a plurality (e.g., four) of first bus bars 310 may be provided side by side in the width direction (e.g., the Y-axis direction) of the battery pack 10. Each of the first bus bars 310 may connect two battery cells C in series, and the two battery cells C connected in series may be connected in parallel to each other by the second bus bar 320. Both sides of the first bus bar 310 may be in contact with two adjacent battery cells C.

as shown in FIG. 6, the first bus bar 310 may include first protrusion portions 311 and first concave portions 312. The first protrusion portions 311 may be formed at the center in the longitudinal direction (e.g., the X-axis direction) of the first bus bar 310 and on both sides that are spaced apart from the center. An upper surface of the first protrusion portion 311 may be lower than the upper end of the rib 112 and/or the lower end of the heat sink 400.

The first concave portions 312 may be formed between the first protrusion portions 311. The first concave portions 312 and the first protrusion portions 311 may hold and support the heat transfer material 500 together with the rib 112 and the leg 420 of the heat sink 400. A connection portion between the first concave portion 312 and the first protrusion portion 311 may be an inclined surface. At least a part of the leg 420 may be on the first concave portion 312.

A first hole 3121 may be formed in the first concave portion 312. The first hole 3121 may be an element for welding (e.g., laser welding or ultrasonic welding) the battery cell C and the first bus bar 310. The first hole 3121 may discharge gas generated in the battery cell C to outside of the battery pack 10, or a wiring may pass through the first hole 3121 into the battery pack 10.

The first bus bar 310 may be at the center in the longitudinal direction of the battery pack 10, the first bus bar 310 may include the first protrusion portion 311 and the first concave portion 312 adjacent to the first protrusion portion 311. The heat transfer material 500 may be accommodated on the first protrusion portion 311 and in the first concave portion 312 and may be between two heat sinks 400 that face each other.

The second bus bar 320 may connect battery cells C to each other. The second bus bar 320 may include the plurality of second bus bars 320 on both sides in the longitudinal direction of the battery pack 10. The second bus bar 320 may connect two battery cells C connected in series by the first bus bar 310. As shown in FIG. 4, each of the second bus bars 320 may have a flat square plate shape, and there may be two of the second bus bars 320 at a first end and one at a second end (e.g., two at the right and one at the left in FIG. 4) in the longitudinal direction of the battery pack 10. The second bus bars 320 may connect two pairs of battery cells C that are connected in series in parallel with each other. Both sides of the second bus bar 320 may be in contact with two adjacent battery cells C.

The second bus bar 320 may include a second protrusion portion 321 and second concave portions 322. As illustrated in FIG. 7, the second protrusion portion 321 may have a T shape. An upper surface of the second protrusion portion 321 may be below the upper end of the rib 112 and/or the lower end of the heat sink 400.

The second concave portions 322 may be formed adjacent to the second protrusion portion 321. The second concave portions 322 may be formed with the second protrusion portion 321 disposed therebetween, and the second concave portion 322 may form a step with the second protrusion portion 321. For example, as shown in FIG. 7, the two second concave portions 322 face each other with a part extending from the second protrusion portion 321 having the T shape in one direction (e.g., the X-axis direction) disposed therebetween. The heat transfer material 500 may be held and supported in each of the second concave portions 322. The second concave portions 322 may correspond to different battery cells C.

The second concave portions 322 and the second protrusion portion 321 may hold and support the heat transfer material 500 together with the rib 112 and the leg 420. A connection portion between the second concave portion 322 and the second protrusion portion 321 may be an inclined surface. At least a part of the leg 420 of the heat sink 400 may be positioned in the second concave portion 322.

A second hole 3221 may be formed in the second concave portion 322. The second hole 3221 may be an element for welding (e.g., laser welding or ultrasonic welding) the battery cell C and the second bus bar 320. The second hole 3221 may discharge gas generated in the battery cell C to outside of the battery pack 10, or a wiring may pass through the second hole 3221 into the battery pack 10.

The second bus bar 320 may include three second bus bars 320 disposed on both sides in the longitudinal direction of the battery pack 10. Each of the second bus bars 320 may include the second protrusion portion 321 and second concave portions 322 adjacent to the second protrusion portion 321. The heat transfer material 500 may be accommodated on the second protrusion portion 321 and in the second concave portions 322.

The third bus bar 330 may be on one side in the longitudinal direction of the battery pack 10. The third bus bar 330 may connect the plurality of battery cells C to a controller, such as a BMS, outside of the battery pack 10. The third bus bar 330 may include two third bus bars 330 at the second end (e.g., the left side with respect to FIG. 4) in the longitudinal direction (e.g., the X-axis direction of FIG. 4) of the battery pack 10. Each of the two third bus bars 330 may be connected to different battery cells C. The other side of the third bus bar 330 may be connected to the external controller (such as a BMS). As shown in FIG. 4, the two third bus bars 330 may face each other with the second bus bars 320 disposed therebetween. The third bus bar 330 may have a shape bent at a certain angle. For example, the third bus bar 330 may have an “L” shape in which a part substantially vertically bent. Two third bus bars 330 may be spaced apart from each other in the width direction (e.g., the Y-axis direction) of the battery pack 10 and one second bus bar 320 may be disposed between the third bus bars 330.

as shown in FIG. 8, the third bus bar 330 may include a third protrusion portion 331, a third concave portion 332, a connection portion 333, and a contact portion 334.

The third protrusion portion 331 may be formed on one side of the third bus bar 330, for example, on the upper surface of one end of the third bus bar 330. The third concave portion 332 may be formed in a portion adjacent to the third protrusion portion 331, and the third concave portion 332 may form a step with the third protrusion portion 331. The connection portion 333 may be a bent portion of the third bus bar 330 and connect the third protrusion portion 331 to the contact portion 334. The contact portion 334 may extend downward in the height direction (e.g., the Z-axis direction of FIG. 8) of the battery pack 10 from the connection portion 333. The contact portion 334 may be exposed to outside of the housing 100 while the third bus bar 330 is in contact with the battery cell C. Thus, an external device may be connected to the third bus bar 330 through the exposed contact portion 334.

The third protrusion portion 331, the third concave portion 332, and the connection portion 333 may hold and support the heat transfer material 500 together with the rib 112 and the leg 420. A connection portion between the third concave portion 332 and the third protrusion portion 331 and a connection portion between the connection portion 333 and the third concave portion 332 may be inclined surfaces. At least a part of the leg 420 of the heat sink 400 may be on the third concave portion 332.

A third hole 3321 may be formed in the third concave portion 332. The third hole 3321 may be an element for welding (e.g., laser welding or ultrasonic welding) the battery cell C and the third bus bar 330. The third hole 3321 may discharge gas generated in the battery cell C to outside of the battery pack 10, or a wiring may pass through the third hole 3321 into the battery pack 10.

The third bus bar 330 may be positioned on one side in the longitudinal direction of the battery pack 10 and include the third protrusion portion 331 and the third concave portion 332 adjacent to the third protrusion portion 331. The heat transfer material 500 may be accommodated on the third protrusion portion 331 and in the third concave portion 332.

The third bus bar 330 may include the connection portion 333 adjacent to the third concave portion 332. The heat transfer material 500 applied to the third bus bar 330 may be also applied to the connection portion 333 and cover at least a part of the leg 420 outside of the heat sink 400 in the longitudinal direction of the battery pack 10.

The heat sink 400 may be positioned on the plurality of bus bars 300. The heat sink 400 may be on one side of the cover 200 and be configured to discharge heat generated in the plurality of battery cells C and the plurality of bus bars 300 to outside of the battery pack 10. As shown in FIG. 9, the heat sink 400 may be positioned on an upper inner surface of the cover 200 and on the plurality of bus bars 300. The heat sink 400 may correspond to the vent holes of the plurality of battery cells C and be spaced apart from the plurality of battery cells C. The heat sink 400 may be spaced apart from the plurality of bus bars 300 to prevent short circuits. The heat sink 400 may form a gap with the plurality of bus bars 300 in the height direction (e.g., the Z-axis direction of FIG. 2) of the battery pack 10. And the heat transfer material 500 may be applied in the gap. The heat transfer material 500 may transfer heat from the plurality of battery cells C and the plurality of bus bars 300 to the heat sink 400, and the heat sink 400 may discharge heat to outside of the battery pack 10 through heat dissipation slits of the cover 200. The heat sink 400 may include a material having excellent thermal conductivity, for example, aluminum or copper.

There may be a plurality of heat sinks 400. For example, as shown in FIG. 2, the heat sink 400 may include two heat sinks 400. The two heat sinks 400 may each be positioned on the plurality of battery cells C. The two heat sinks 400 may be spaced apart from each other. The heat transfer material 500 may be accommodated on the first protrusion portion 311 and in the first concave portion 312 and may be provided between the two heat sinks 400 facing each other. The heat sinks 400 may be provided in the same number as the battery cells C connected in series. For example, if two battery cells C are connected in series to each other, two heat sinks 400 may be provided. Each of the heat sinks 400 may be arranged in the width direction of the battery pack 10.

The heat sink 400 may include the body 410 and the leg 420.

The body 410 may have a flat plate shape and include the plurality of windows 411 formed therein. The plurality of windows 411 may be formed in the same number as the plurality of battery cells C corresponding to one body 410. Each of the windows 411 may correspond to the vent hole of each of the battery cells C. If gas is generated due to an abnormality in the battery cell C, the gas moving through the vent hole and the window 411 may be discharged to outside of the battery pack 10 through heat dissipation slits of the cover 200. As shown in FIG. 10, the window 411 may be rectangular, but, in other embodiments may be circular, oval, or polygonal. Four windows 411 may be spaced apart in the longitudinal direction (e.g., the Y-axis direction) of the heat sink 400 and formed on one body 410.

The leg 420 may include a plurality of legs 420, and the plurality of legs 420 may be configured to transfer heat from the battery cells C and the plurality of bus bars 300 to the body 410. To this end, at least a part of the leg 420 may be below the body 410 and closer to the bus bar 300. For example, as shown in FIG. 10, the leg 420 may include the plurality of legs 420 on both sides of the body 410 in the width direction (e.g., the X-axis direction) of the heat sink 400. For example, legs 420 may be positioned on both sides of the windows 411, and one heat sink 400 may have a total of eight legs 420. The legs 420 may be spaced apart from the bus bar 300 in the height direction (e.g., the Z-axis direction of FIG. 5) of the battery pack 10.

Each of the legs 420 may include an extension portion 421 and a connection portion 422. The extension portion 421 may be connected to the body 410 through the connection portion 422 extending downward from the body 410, and transfer heat generated from the bus bar 300 to the body 410. The extension portion 421 may extend in one direction (e.g., the X-axis direction) parallel to the body 410 and/or the bus bar 300. The extension portion 421 may be below the body 410. An upper surface of the extension portion 421 may be below a lower surface of the body 410. The extension portion 421 may extend from the connection portion 422 in the longitudinal direction of the battery pack 10, and at least a part of the extension portion 421 may be surrounded by the heat transfer material 500.

The extension portion 421 may correspond to the bus bar 300. As shown in FIGS. 11 and 12, the plurality of legs 420 of the heat sinks 400 may positioned above the first bus bar 310 and the second bus bar 320. Also, as shown in FIGS. 11 and 13, the plurality of legs 420 may be positioned above the first bus bar 310 and the third bus bar 330.

The extension portion 421 may be surrounded by the heat transfer material 500 when the heat transfer material 500 is applied to the bus bar 300. As the extension portion 421 may be surrounded by the heat transfer material 500, heat may be efficiently transferred from the heat transfer material 500 to the heat sink 400.

In the heat sink 400 corresponding to the first bus bar 310, a first end of the extension portion 421 may be on the first protrusion portion 311. A second end of the extension portion 421 may be on the first concave portion 312.

In the heat sink 400 corresponding to the second bus bar 320, one end of the extension portion 421 may be on the second protrusion portion 321. The other end of the extension portion 421 may be positioned above the second concave portion 322.

In the heat sink 400 corresponding to the third bus bar 330, a first end of the extension portion 421 may be positioned above the third protrusion portion 331. The second end of the extension portion 421 may be positioned above the third concave portion 332.

The heat transfer material 500 may be provided on the bus bar 300 and transfer heat discharged from the plurality of battery cells C and the bus bar 300 to the heat sink 400. The heat transfer material 500 may be viscous and applied between the bus bar 300 and the heat sink 400. The heat transfer material 500 may be, for example, a polymer, such as a dimethylsiloxane resin, an epoxy resin, an acrylate resin, an organic polysiloxane resin, a polyimide resin, a fluorocarbon resin, a benzocyclobutene resin, a fluorinated polyallyl ether resin, a polyamide resin, a polyimidamide resin, a cyanoate ester resin, a phenol resol resin, an aromatic polyester resin, a polyphenylene ether resin, a bismaleimide triazine resin, a fluoro resin, or a combination or blend of polymers. The heat transfer material 500 may be applied on one or more protrusion portions and in one or more concave portions formed on the bus bar 300.

The heat transfer material 500 may be applied to the bus bar 300 and then cured through a certain post-treatment such as heating so that the cured heat transfer material 500 maintains its shape. In another embodiment, the heat transfer material 500 may have high viscosity to maintain substantially the same shape as the shape applied initially without a separate post-treatment.

An upper surface of the heat transfer material 500 applied to the bus bar 300 may be above an upper surface of the extension portion 421. Therefore, the extension portion 421 may be surrounded by the heat transfer material 500 so that heat generated by the bus bar 300 may be smoothly transferred to the heat sink 400 through the extension portion 421 via the heat transfer material 500.

The heat transfer material 500 may be in contact with the connection portion 422 or cover at least a part of the connection portion 422. The heat transfer material 500 may be in contact with the body 410 or cover at least a part of the body 410.

The housing 100 may include the upper case 110 detachably mounted on an upper portion thereof. As shown in FIG. 4, the upper case 110 may include the rib 112 extending in the longitudinal direction of the battery pack 10, and the heat transfer material 500 may be accommodated between the bus bar 300 and the rib 112.

The heat transfer material 500 may be applied to a region partitioned by the bus bar 300 and the heat sink 400. The heat transfer material 500 may cover at least a part of the bus bar 300, and at least a part of the heat sink 400 may be surrounded by the heat transfer material 500. The upper surface of the heat transfer material 500 may be above an upper surface of the leg 420 of the heat sink 400, and the heat transfer material 500 may surround at least a part of the leg 420. After the heat transfer material 500 is applied to the bus bar 300 before the cover 200 is covered, and the cover 200 may be mounted on the housing 100.

The heat transfer material 500 may correspond to the first bus bar 310. That is, the heat transfer material 500 may be applied on the first bus bar 310. For example, a part of the heat transfer material 500 may be accommodated in the first concave portion 312 of the first bus bar 310. The heat transfer material 500 may be accommodated between two different legs 420 of the heat sink 400 facing each other. The heat transfer material 500 may be accommodated between two ribs 112 spaced apart in one direction (e.g., the Y-axis direction). Thus, as shown in FIG. 11, the heat transfer material 500 may be applied to a region partitioned by the rib 112, the first bus bar 310, and the leg 420. The drawings illustrate that the heat transfer material 500 has a substantially rectangular cross section, but the shape of the heat transfer material 500 is not limited thereto. For example, the heat transfer material 500 may have a shape that is wider at the bottom due to its own weight.

The heat transfer material 500 applied to the first bus bar 310 may have an upper surface above the upper surface of the extension portion 421. Therefore, the extension portion 421 may be surrounded by the heat transfer material 500. Thus, heat generated from the first bus bar 310 may be smoothly transferred to the heat sink 400 through the extension portion 421 via the heat transfer material 500.

Both ends of the heat transfer material 500 may be provided on the first protrusion portions 311 in the longitudinal direction (e.g., the X-axis direction) of the battery pack 10. The ends of the heat transfer material 500 may be below the leg 420 in the longitudinal direction (e.g., the X-axis direction) of the battery pack 10.

The heat transfer material 500 may correspond to the second bus bar 320. That is, the heat transfer material 500 may be applied on the second bus bar 320. For example, a part of the heat transfer material 500 may be accommodated in the second concave portion 322 of the second bus bar 320. The heat transfer material 500 may cover at least a part of the leg 420 of one heat sink 400. The heat transfer material 500 may be accommodated between two ribs 112 that are spaced apart in one direction (e.g., the Y-axis direction). Therefore, as shown in FIG. 12, the heat transfer material 500 may be applied to a region partitioned by the rib 112, the second bus bar 320, and the leg 420. The drawings illustrate that the heat transfer material 500 has a substantially rectangular cross section, but the shape of the heat transfer material 500 is not limited thereto. For example, the heat transfer material 500 may have a shape that is wider at the bottom due to its own weight.

The heat transfer material 500 applied to the second bus bar 320 may have an upper surface above the upper surface of the extension portion 421. Therefore, the extension portion 421 may be surrounded by the heat transfer material 500. Thus, heat generated from the second bus bar 320 may be smoothly transferred to the heat sink 400 through the extension portion 421 via the heat transfer material 500.

The heat transfer material 500 may have one end (e.g., an inner end) above the second protrusion portion 321 in the longitudinal direction (e.g., the X-axis direction) of the battery pack 10. The heat transfer material 500 may have one end below the leg 420 in the longitudinal direction (e.g., the X-axis direction) of the battery pack 10.

FIG. 12 shows only a left end of the heat transfer material 500 corresponding to the second bus bar 320 with respect to the drawing. But a right end of the heat transfer material 500 may be additionally supported by a wall of the upper case 110.

The heat transfer material 500 may correspond to the third bus bar 330. That is, the heat transfer material 500 may be applied on the third bus bar 330. For example, a part of the heat transfer material 500 may be accommodated in the third concave portion 332 of the third bus bar 330. The heat transfer material 500 may cover at least a part of the leg 420 of one heat sink 400. The heat transfer material 500 may be accommodated between two ribs 112 that are spaced apart in one direction (e.g., the Y-axis direction). Therefore, as shown in FIG. 13, the heat transfer material 500 may be applied to a region partitioned by the rib 112, the third bus bar 330, and the leg 420. The drawings illustrate that the heat transfer material 500 has a substantially rectangular cross section, but the shape of the heat transfer material 500 is not limited thereto. For example, the heat transfer material 500 may have a shape that is wider at the bottom due to its own weight.

The heat transfer material 500 applied to the third bus bar 330 may have an upper surface above the upper surface of the extension portion 421. Therefore, the extension portion 421 may be surrounded by the heat transfer material 500 so that heat generated by the third bus bar 330 may be smoothly transferred to the heat sink 400 through the extension portion 421 via the heat transfer material 500.

As shown in FIGS. 11 to 13, the heat transfer material 500 corresponding to each of the first bus bar 310, the second bus bar 320, and the third bus bar 330 may cover only the extension portion 421 without contacting the connection portion 422. Further, the heat transfer material 500 corresponding to each of the first bus bar 310, the second bus bar 320, and the third bus bar 330 may contact the connection portion 422 or cover at least a part of the connection portion 422. Still further, the heat transfer material 500 corresponding to each of the first bus bar 310, the second bus bar 320, and the third bus bar 330 may contact the body 410 or cover at least a part of the body 410.

The heat transfer material 500 applied to the second bus bar 320 may cover at least a part of the leg 420 outside of the heat sink 400 in the longitudinal direction of the battery pack 10. The heat transfer material 500 applied to the third bus bar 330 may cover at least a part of the leg 420 outside of the heat sink 400 in the longitudinal direction of the battery pack 10.

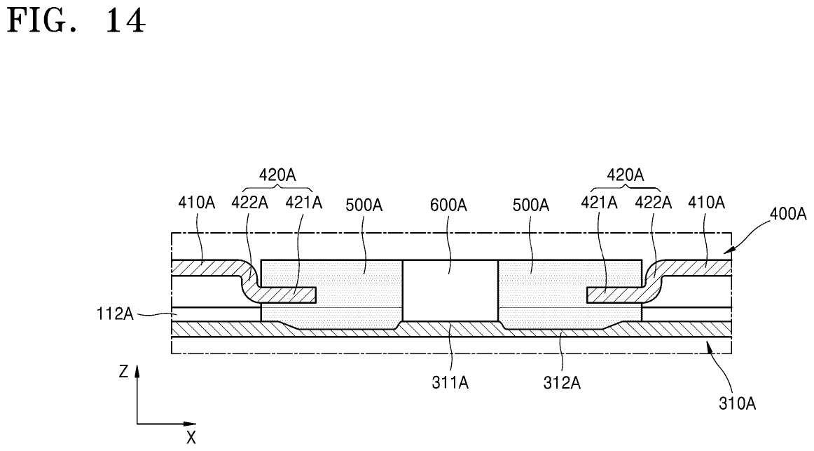

FIG. 14 is a cross-sectional view taken along line A-A′ of FIG. 3 according to embodiments of the present disclosure.

The embodiment illustrated in FIG. 14 may be different from the above-described embodiment with respect to a heat transfer material 500A. In particular, this embodiment may further include a wall portion 600A extending upward from a first protrusion portion 311A, thereby dividing the heat transfer material 500A applied to a first bus bar 310A into two parts. The other parts and configurations are the same as the parts and configurations of the above-described embodiment. Hereinafter, the wall portion 600A will be mainly described. Configurations not shown in FIG. 14 are the same as the configurations of the above-described embodiment, and reference numerals are the same as in the above-described embodiment.

The heat transfer material 500A corresponding to the first bus bar 310A may be accommodated on the first protrusion portion 311A and in a first concave portion 312A of the first bus bar 310A. The heat transfer material 500A may be supported by a rib 112A and cover an extension portion 421A of a leg 420A of a heat sink 400A. The heat transfer material 500A may not be in contact with a connection portion 422A. In other embodiments, the heat transfer material 500A may be in contact with the connection portion 422A or cover at least a part of the connection portion 422A. The heat transfer material 500A may be in contact with the body 410A or cover at least a part of the body 410A. The heat transfer material 500A corresponding to the first bus bar 310A may be applied to a region partitioned between the first bus bar 310A, the rib 112A, and two legs 420A.

The wall portion 600A may be formed above the first bus bar 310A. As shown in FIG. 14, the wall portion 600A may be above the first protrusion portion 311A of the first bus bar 310A and protrude to a certain height. A height of the wall portion 600A may be higher than upper ends of the rib 112A, the first bus bar 310A, and the extension portion 421A. The height of the wall portion 600A may be the same as, lower than, or higher than an upper surface of the body 410A. One wall portion 600A may be provided for each first bus bar 310A, partition the heat transfer material 500A into two parts with respect to the first protrusion portion 311A, and support the heat transfer material 500A. Therefore, the shape of the heat transfer material 500A may be more reliably maintained so that the heat transfer material 500A may have a height higher than that of the extension portion 421A. The heat transfer material 500A may be applied to the first concave portion 312A of the first bus bar 310A where heat is generated intensively, thereby increasing heat dissipation efficiency relative to the total amount of heat transfer material 500A.

The battery pack according to embodiments may include a heat sink and a heat transfer material, thereby efficiently dissipating heat generated in battery cells and bus bars to the outside of the battery pack.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the present disclosure.

What is claimed is:

1. A battery pack comprising:
a plurality of battery cells, each of the battery cells including a vent;
a housing accommodating the battery cells;
a cover covering an upper surface of the housing;
a bus bar connecting the battery cells to each other;
a heat sink is positioned on the cover; and
a heat transfer material applied to the bus bar and covering at least a part of the heat sink,
wherein the heat sink includes a body comprising a plurality of windows that are positioned to correspond to the vents of the battery cells; and
a leg extending from the body toward the bus bar.

2. The battery pack as claimed in claim 1, wherein the leg is spaced apart from the bus bar in a height direction of the battery pack.

3. The battery pack as claimed in claim 1, wherein the leg comprises:
a connection portion extending downward from the body; and
an extension portion extending from the connection portion in a longitudinal direction of the battery pack and at least partially surrounded by the heat transfer material.

4. The battery pack as claimed in claim 3, wherein an upper surface of the heat transfer material is positioned above an upper surface of the extension portion.

5. The battery pack as claimed in claim 1, wherein the bus bar includes at least one protrusion portion and at least one recess formed therein, and
wherein the heat transfer material is applied to the at least one protrusion portion and the at least one recess.

6. The battery pack as claimed in claim 1, wherein the housing comprises a detachable upper case, the upper case comprises a rib extending in a longitudinal direction of the battery pack, and the heat transfer material is accommodated between the bus bar and the rib.

7. The battery pack as claimed in claim 6, wherein the rib comprises a plurality of ribs arranged side by side in the longitudinal direction of the battery pack, and the plurality of ribs partitions a region in which the plurality of battery cells are accommodated in the housing.

8. The battery pack as claimed in claim 6, wherein an upper end of the rib is positioned above an upper surface of the bus bar.

9. The battery pack as claimed in claim 1, wherein the bus bar comprises a first bus bar, a second bus bar, and a third bus bar that connect the battery cells to each other, and
wherein the heat transfer material is applied to each of the first bus bar, the second bus bar, and the third bus bar.

10. The battery pack as claimed in claim 9, wherein the first bus bar is positioned at a center in a longitudinal direction of the battery pack, and the first bus bar comprises a protrusion portion and a concave portion adjacent to the protrusion portion,
wherein the heat sink comprises two heat sinks that face each other, and
wherein the heat transfer material is accommodated on the protrusion portion and in the concave portion and is between the two heat sinks.

11. The battery pack as claimed in claim 10, wherein at least part of the leg is positioned above the concave portion.

12. The battery pack as claimed in claim 10, further comprising a wall portion extending upward from the protrusion portion and dividing the heat transfer material applied to the first bus bar into two parts.

13. The battery pack as claimed in claim 9, wherein the second bus bar comprises a plurality of second bus bars positioned on both sides of the battery pack in a longitudinal direction, each of the second bus bars comprises a protrusion portion and a concave portion adjacent to the protrusion portion, and the heat transfer material is accommodated on the protrusion portion and in the concave portion.

14. The battery pack as claimed in claim 13, wherein the protrusion portion has a T-shape, the concave portion comprises two concave portions facing each other with a part of the protrusion portion disposed between the two concave portions, and the two concave portions correspond to different battery cells of the plurality of battery cells.

15. The battery pack as claimed in claim 13, wherein the heat transfer material applied to the second bus bar covers at least a part of the leg of the heat sink in the longitudinal direction of the battery pack.

16. The battery pack as claimed in claim 13, wherein at least part of the leg of the heat sink is positioned above the concave portion.

17. The battery pack as claimed in claim 9, wherein the third bus bar is positioned on one side of the battery pack in a longitudinal direction, and the third bus bar comprises a protrusion portion and a concave portion adjacent to the protrusion portion, and
wherein the heat transfer material is accommodated on the protrusion portion and the concave portion.

18. The battery pack as claimed in claim 17, wherein the third bus bar comprises a connection portion adjacent to the concave portion, and
wherein the heat transfer material is applied to the connection portion and covers at least a part of the leg of the heat sink in the longitudinal direction of the battery pack.

19. The battery pack as claimed in claim 17, wherein at least a part of the leg of the heat sink is positioned above the concave portion.

20. A battery pack comprising:
a plurality of battery cells, each of the battery cells including a vent;
a housing accommodating the battery cells and comprising an upper case that includes a rib;
a cover covering an upper surface of the housing;
a bus bar connecting the plurality of battery cells to each other, and the bus bar including at least one protrusion portion and at least one concave portion;
a heat sink positioned on the cover, the heat sink comprising a body comprising a plurality of windows that are positioned to correspond to the vents of the plurality of battery cells, and a leg extending from the body toward the bus bar and positioned above an upper surface of the bus bar; and
a heat transfer material accommodated on the at least one protrusion portion, in the at least one concave portion, on the rib, and covering at least a part of the heat sink.
